(19) United States
(12) Patent Application Publication
(10) Pub. No.: US 2004/0015947 A1
(43) Pub. Date: Jan. 22, 2004

(54) CLIENT TO CLIENT DISTRIBUTION THROUGH A NETWORK

(76) Inventors: QING GONG, BOYNTON BEACH, FL (US); HUIFANG WANG, BOYNTON BEACH, FL (US)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(21) Appl. No.: 09/251,789

(22) Filed: Feb. 17, 1999

(51) Int. Cl. G06F 9/44

(52) U.S. Cl. 717/170

(57) ABSTRACT

A method for changing client software on a network comprising the steps of: connecting a plurality of information processing systems by a network; running a first software application with a first version on at least one of the information processing systems; running a second software application with a second version on at least one of the information processing systems; querying the second application over the network to determine if the version of second application is newer than the first application. In accordance with another embodiment of the present invention, an information processing system and computer readable storage medium is disclosed for carrying out the above method.

### CROSS-REFERENCE TO RELATED APPLICATIONS

Not applicable

### BACKGROUND OF THE INVENTION

1. Field of the Invention

The invention disclosed broadly relates to the field of network computing, and more particularly relates to the field of software distribution through networks.

2. Description of the Related Art

The use of networks and network computers continues to grow. One recent development is the Internet and of the World Wide Web (“Web”). The Web has become immensely popular largely because of the ease of finding information and the user-friendliness of today's browsers. A feature known as hypertext allows a user to access information from one Web page to another Web page by simply pointing with a mouse or equivalent pointing device at the hypertext and clicking. Another feature that makes the Web attractive is having the ability to process the information in remote Web pages without the requirement of having a specialized application program for each kind of content accessed. Thus, the same content is viewed across different platforms. Browser technology has evolved to enable the running of applications that manipulate this content across a wide variety of different platforms. Networks using Web browser servers and technologies for use inside organizations and corporations, called Intranets have also grown in use.

The ease of use of Intranets, Internet, and other networks has made the delivery of electronic files and particularly programs very easy. There are numerous Web sites such as http://www.zdnet.com/swlib/hotfiles/top50free.html, in which a user can download free software over the Internet. The use of network servers and Web servers as distribution centers for software and other content eliminates the cost of manufacturing and the cost of sending physical objects such as Compact Disks, diskettes, tapes and other media to customers and end-users. While the use of electronic distribution from a server to a client, often referred to client-server topology, is cost effective, it is not without its disadvantages.

One disadvantage for client-server topologies is found where a Web server or network server must distribute files to a large number of clients concurrently. The server must have the capacity to serve all clients in a reasonable amount of time. As networks such as the Web and the Internet grow larger, the capacity of the network server must corresponding grow. An example would be the availability of a new version of a popular program such as a new Web browser, for example, Netscape Navigator or Microsoft Internet Explorer. The demand for the new version of software may be very great and the capacity of the Web server to electronically distribute this new version may be limited. The cost of larger Web servers can be prohibitive. In many cases, a small entity or corporation can not afford a large Web server or a mainframe. Accordingly, a need exists for a cost effective method to distribute software to a large number of clients concurrently without the need of a large server.

Another disadvantage for client-server topologies is that the bandwidth of the network, and sub-networks between the server and the client is limited. This can especially true where for example, where the same file from a Web server must be sent through one gateway or Internet Firewall at a company and redistributed identical copies of the file to clients within the gateway and firewall. Many times the overall bandwidth and the available bandwidth of a local Intranet at any given time is much greater than the available bandwidth on the Internet. It is not uncommon for the response time on an Intranet to be faster than the response time on the Internet. The users of traditional client-server electronic distribution can not make use of the extra available local network bandwidth. Accordingly, a need exists for a method and apparatus to increase the use of local networks to distribute files whenever possible.

### SUMMARY OF THE INVENTION

Briefly, in accordance with the present invention, a method for changing client software on a network comprises the steps of: connecting a plurality of information processing systems by a network; running a first version of a first software application on at least one of the information processing systems; running a second version of a second software application on at least one of the information processing systems; querying the second application over the network to determine if the version of second application is newer than the version of the first application. In accordance with another embodiment of the present invention, an information processing system and computer readable storage medium is disclosed for carrying out the above method.

### BRIEF DESCRIPTION OF THE DRAWINGS

FIG. 1 is a block diagram of the major electrical components of an information processing system according to the present invention.

FIG. 2 is a block diagram illustrating the software hierarchy for the information processing device of FIG. 1 according to the present invention.

FIG. 3 is a functional block diagram of a typical data processing system for hosting Web applications according to the present invention.

FIG. 4 is a flow diagram for a peer client application for updating a first client with an application according to the present invention

FIG. 5 is a block diagram of the client-server component of two peer client applications for updating a first client with an application according to the present invention.

### DETAILED DESCRIPTION OF AN EMBODIMENT

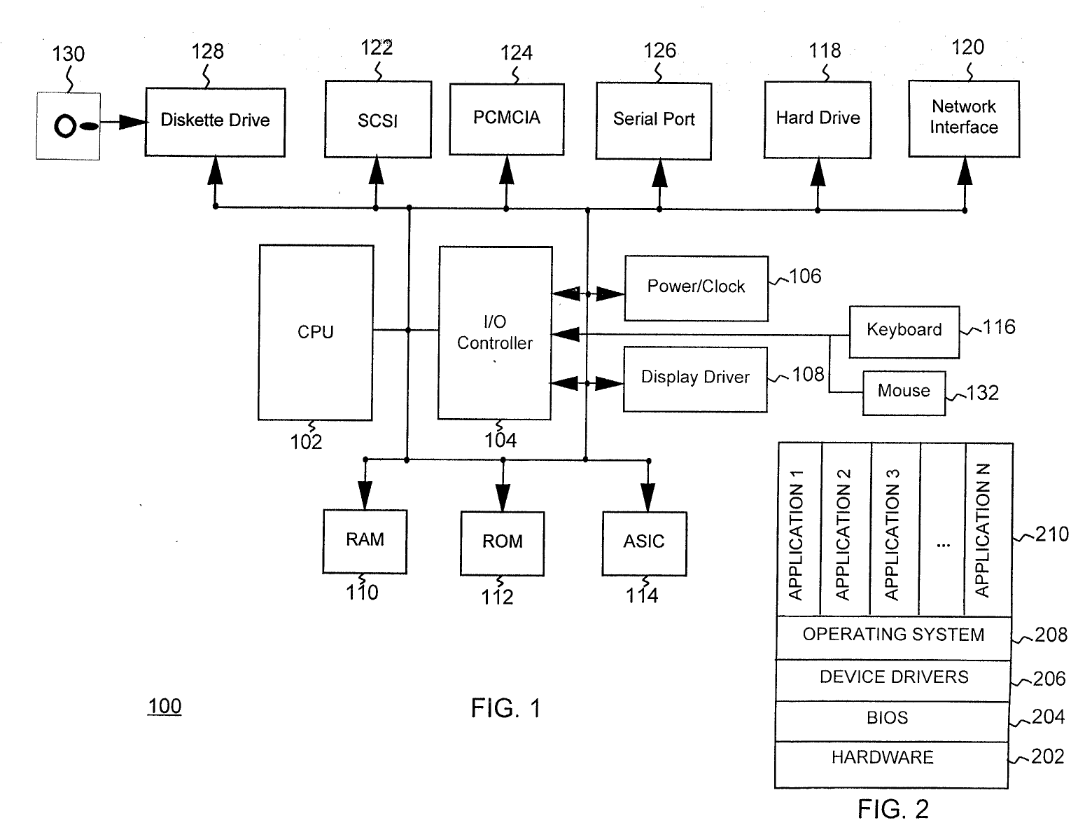

Referring to FIG. 1, there is shown a block diagram of the major electrical components of an information processing system 100 in accordance with this invention. The electrical components include: a central processing unit (CPU) 102, an Input/Output (I/O) Controller 104, a system power and clock source 106; display driver 108; RAM 110; ROM 112; ASIC (application specific integrated circuit) 114 and a hard disk drive 118. A keyboard 116 with a mouse 132 receives the user input. These are representative components of a computer. The operation of a computer comprising these elements is well understood. Network interface 120 provides connection to a computer network such as Ethernet, TCP/IP or other popular protocol network interfaces. Optional components for interfacing to external peripherals include: a Small Computer Systems Interface (SCSI) port 122 for attaching peripherals; a PCMCIA slot 124; and serial port 126. An optional diskette drive 128 is shown for loading or saving code to removable diskettes 130 or equivalent computer readable media. The system 100 may be implemented by combination of hardware and software. Moreover, the functionality required for using the invention may be embodied in computer-readable media (such as 3.5 inch diskette 130) to be used in programming an information-processing apparatus (e.g., a personal computer) to perform in accordance with the invention.

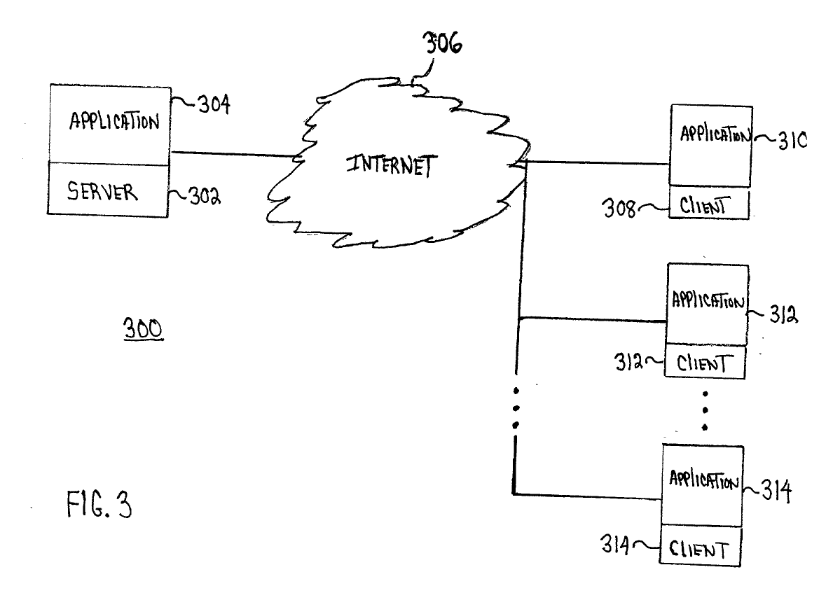

FIG. 2 is a block diagram illustrating the software hierarchy for the information processing system of FIG. 1 according to the present invention. The hardware 202 is the information processing system of FIG. 1. BIOS (Basic Input Output System) 204 is a set of low level of computer hardware instructions, usually stored in ROM 112, for communications between an operating system 208, device driver(s) 206 and hardware 202. Device drivers 206 are hardware specific code used to communicate between and operating system 208 and hardware peripherals such as a mouse 132, CD ROM drive or printer. Applications 210 are software application written in C/C++, Java, assembler or equivalent. Operating system 208 is the master program that loads after BIOS 204 initializes, that controls and runs the hardware 202. Examples of operating systems include DOS, Windows 3.1/95/98/NT, Unix, Macintosh, OS/2 and equivalent.

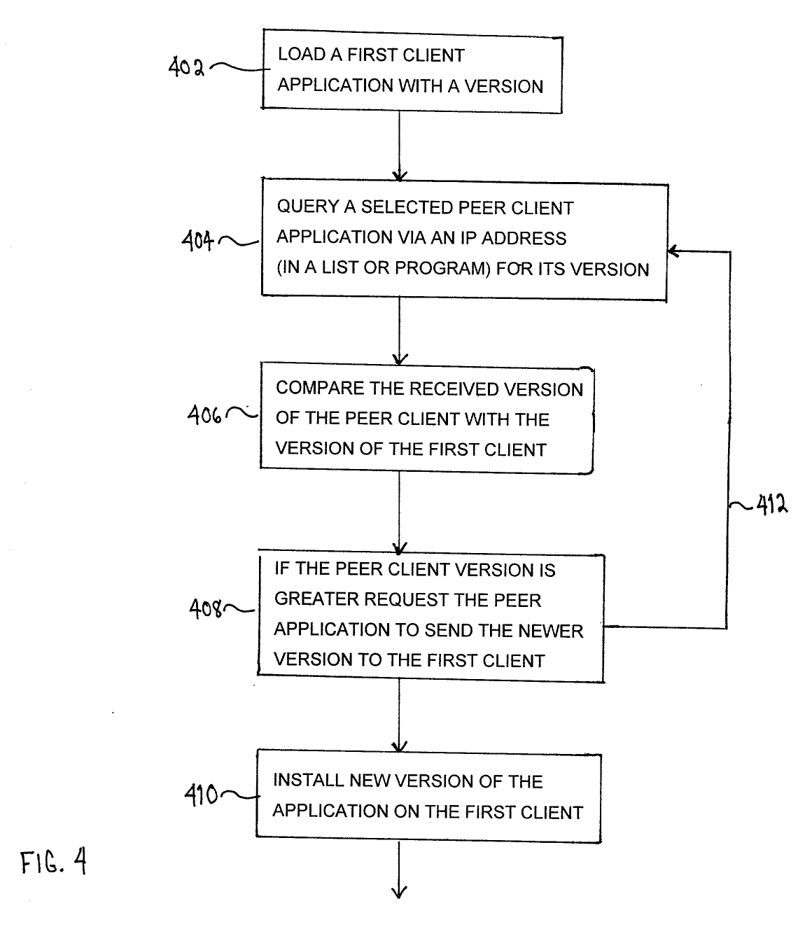

FIG. 3 depicts a functional block diagram of a typical data processing system for hosting Web applications 300. A Web server 302 with a Web server application 304. The Web server 302 is connected to the Internet 306. An end-user information processing system 100 with a client application 210 such as a Web browser or a Web chat client are connected to the Internet 306. The Web chat client application 210 is any software capable of creating a socket connection and performing a stream data transfer such as the IBM Internet Relay Chat (IRC) client for Java software. In another embodiment, the application 210 can use FTP (File-Transfer-Protocol) to send data. It should be understood that other applications such a Web browser with FTP capabilities may be substituted for client application 210 to carry out this invention. Examples of Web browser clients using FTP protocol include Netscape Navigator, Sun Hot Java Browser, Microsoft Internet Explorer or equivalent. Web server 302 is a PC Server such as Sun Sparc Server, IBM's PC Server, IBM AS/400, IBM ES/9000 or equivalent server hardware platforms capable of hosting Web applications. These client-server systems can be implemented on a wide variety of hardware and software platforms. A plurality of client information processing systems are connected to the server. Shown are three peer client information processing systems 308, 312, and 316, each with a different versions 310, 312, 318 of the client application 210.

Turning now to FIG. 4, there is shown a flow diagram for a peer client application for updating a first client with an application according to the present invention. The process begins with an application with a version, the version of the application being delivered to a peer client information processing system 308, step 402. The application can be delivered from the Web server 302 as the application 304 residing on the Web server, from a popular Internet site such as www. netscape.com or www.microsoft.com. In another embodiment, the application can be delivered and installed directly on the client information processing system 308 using computer readable medium 130 without being installed via the Internet 306. Next, the application 304 queries a peer client application either 312 or 316 from a list for its version, step 404. In this embodiment, the application is an Internet chat client using the IRC (Internet Relay Chat) protocol using the ctcpversion command. The list holding the IP address is known for other peer clients 312 or 316 during an Internet chat session. In another embodiment, the list of IP address for other peer clients 312 or 316 can be collected using other methods know in the art such as via E-mail or through List Servers or subscription maintenance directories or equivalent. It should be understood that the contents of this list can be different, that is, comprise a different set of peer clients 312 or 316 depending on the application being loaded in step 402. Once the version from a peer application is received, it is compared with the version of the first client 310, step 406. If the version for the targeted peer clients 314 or 316 is newer than the version of the first client 310, then the application from the corresponding peer clients 314 or 316 is sent from the targeted peer client systems 312 or 314 to the first client system 308 installed on the first client 308 to make them equal, step 408. If the version on the first client is newer or equal to the version of the targeted peer client application 314 or 316, the next IP address in the list, if any, is tested, step 412.

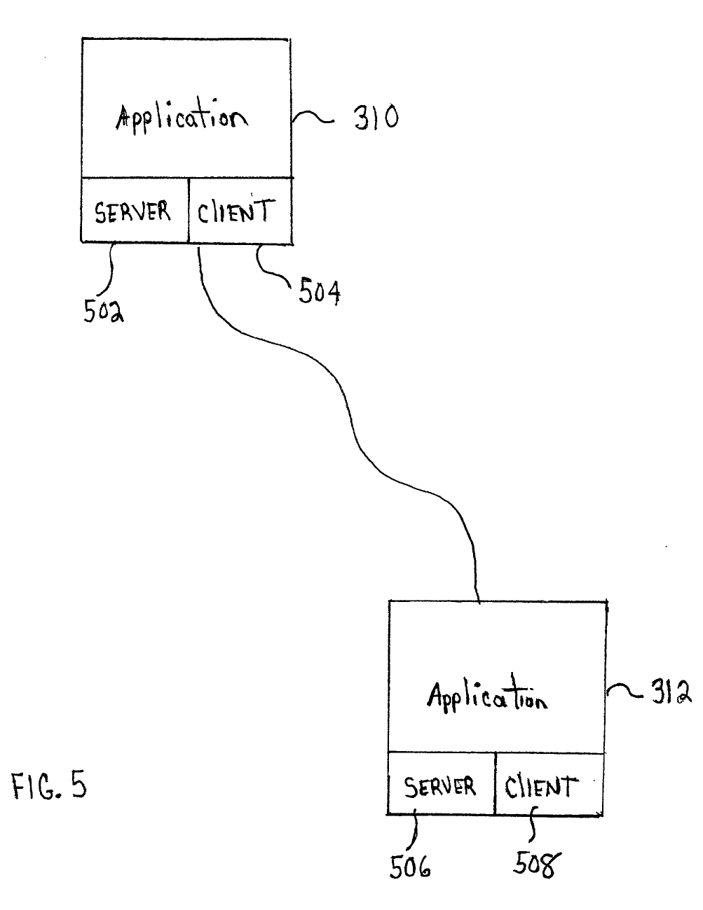

Turning now to FIG. 5, there is shown a block diagram of the client-server component of two peer client applications for updating a first client with an application according to the present invention. The application 310 running on the first client system 308 contains server component 502 and a client component 504. The server component 502 is an application server such as those available from Sun Microsystems known as Java Bean. The client 504, in step 404, requests a socket connection using well known techniques for a corresponding server 506 of application 312 (or any other peer client application on the network such as 316). The server 506 using cpcpversion command or equivalent sends the version of the application 312 to client 504. The client 504 after checking the version, step 406, requests the server 506 to install application 312 in place of application 310.

In another embodiment, instead of using the process flow described above, the application with the first version 310 sends it version information to the application with the second version 312. The application with the second version 312 determines if the application with the first version 310, needs to be updated and sends an update version 312 to the application with the first version 310 if needed.

In still another embodiment, the application 310 includes the ability to check version of components of a peer applications 314 and 318 such as device drivers, plug-ins, text files, help files, or any other component of the application that may be updated separately. This is accomplish by either reading the a component list from the application itself or from the operating system 208 such as the Microsoft Windows' registry under Microsoft Windows 95 and NT.

Although a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A system for changing client software on a network comprising:
a plurality of information processing systems interconnected by a network; at least one of the information processing systems running a software application with a first version; and at least one of the information processing systems running an application with a second version;
means for the application with the first version to query the application with the second version over the network to determine if the version of application with the second version is newer than the application with the first version.

2. The system for changing client software of claim 1, further comprising:
means for updating the application with the first version with the application with the first version if the application with the second version is newer the application with the first version.

3. The system for changing client software of claim 1, wherein the application with a first version and a second version is a chat client.

4. The system for changing client software of claim 1, wherein the application with a first version and a second version is a browser.

5. The system for changing client software of claim 2, wherein the means for the application with the first version to query the application with the second version includes querying one or more distinct components with separate versions of the second application to determine if one or more of the distinct components of the second application are newer than one or more components with distinct versions of the first application.

6. The system for changing client software of claim 5, further comprising:
means for updating at least one component of first application with at least one component of second application if the version of the component for the second application is newer than the version of the component of the first application.

7. The system for changing client software of claim 6 wherein at least one of the components is a plug-in for the application with a first version.

8. The system for changing client software of claim 6 wherein at least one of the components is a device driver for the application with a first version.

9. In a data network comprising a plurality of information processing system interconnected by the network, an information processing device comprising:
a first version of a software application;
a means for receiving a copy of a second version of a software application running on a second information processing system; and
a means for comparing the second version of a software application with the first version of the software application.

10. The information processing system of claim 9, wherein the first version of the application further comprising:
means for updating the first version of the software application with a copy of the second version of the software application if the second version of the application is newer than the first version of the application.

11. The information processing system of claim 9, wherein the network is coupled to the Internet.

12. The information processing system of claim 9, wherein the network is an Intranet.

13. The information processing system of claim 9, wherein the network is comprised of an Intranet coupled to the Internet.

14. A method for changing client software on a network comprising the steps of:
connecting a plurality of information processing systems by a network;
running a first version of a software application on at least one of the information processing systems;
running a second version of a second software application on at least one of the information processing systems;
querying the second application over the network to determine if the version of second application is newer than the version of the first application.

15. The method for changing client software of claim 14, further comprising the step of:
updating the first application with a copy of the second application over the network if the version of the second application is newer the version of the first application.

16. The method for changing client software of claim 14, wherein the step of running a first application includes running a first application that is a chat client and the step of running a second application includes running an application that is a chat client.

17. The method for changing client software of claim 14, wherein the step of running a first application includes running an application that is a browser and the step of running a second application includes running an application that is a browser.

18. The method for changing client software of claim 15, wherein the step of running a first application includes running a first application with distinct components; wherein the step of running a second application includes running a second application with distinct components; and the step of querying the second application includes querying one or more distinct components with separate versions to determine if one or more of the distinct components of the second application are newer than one or more components with distinct versions of the first application.

19. The method for changing client software of claim 18, further comprising the step of:
updating at least one component of the first application with the first version if the second application is newer.

20. The method for changing client software of claim 19 wherein the step of updating least one of the components includes updating a plug-in for the first application.

21. The method for changing client software of claim 19 wherein the step of updating least one of the components includes updating a device driver for the first application.

22. A computer readable storage medium containing program instructions for changing client software on a network, said program instructions comprising instructions for:
connecting a plurality of information processing systems by a network;
running a first version of a first software application on at least one of the information processing systems;
running a second version of second software application on at least one of the information processing systems;
querying the second application over the network to determine if the version of second application is newer than the version of the first application.

23. The computer readable storage medium of claim 22, further comprising the instruction of:
updating the first application with a copy of the second application over the network if the version of the second application is newer the version of the first application.

24. The computer readable storage medium of claim 22, wherein the instruction of running a first application includes running a first application that is a chat client and the step of running a second application includes running an application that is a chat client.

25. The computer readable storage medium of claim 22, wherein the instruction of running a first application includes running an application that is a browser and the instruction of running a second application includes running an application that is a browser.

26. The computer readable storage medium of claim 23, wherein the instruction of running a first application includes running a first application with distinct components; wherein the instruction of running a second application includes running a second application with distinct components; and the instruction of querying the second application includes querying one or more distinct components with separate versions to determine if one or more of the distinct components of the second application are newer than one or more components with distinct versions of the first application.

27. The computer readable storage medium of claim 26, further comprising the instruction of:
updating at least one component of the first application with the first version if the second application is newer.

28. The computer readable storage medium of claim 27, wherein the instruction of updating least one of the components includes updating a plug-in for the first application.

29. The computer readable storage medium of claim 27, wherein the instruction of updating least one of the components includes updating a device driver for the first application.
